(19) United States
(12) Patent Application Publication
(10) Pub. No.: US 2019/0309898 A1
(43) Pub. Date: Oct. 10, 2019

(54) HANGING DEVICE FOR SIDING MEMBERS

(71) Applicant: UNDER THE ROOF DECORATING INC., Calgary (CA)

(72) Inventors: Kelly KRAKE, Calgary (CA); Liette TOUSIGNANT, Calgary (CA); Michael Kurtz, Calgary (CA); Ian Matthew CAMPANA, Calgary (CA)

(21) Appl. No.: 16/373,827

(22) Filed: Apr. 3, 2019

Related U.S. Application Data
(60) Provisional application No. 62/653,717, filed on Apr. 6, 2018.

(51) Int. Cl. F16M 13/02; F16B 45/00; F16B 2/24

(52) U.S. Cl. CPC F16M 13/022; F16B 2/241; F16B 45/00

(57) ABSTRACT

A hanging device attachable to overlapping siding members to support an object. The hanging device includes a support portion having a body defining an outer surface and an inner surface. A retaining structure is on the outer surface of the body to support the object. A support protrusion extends outwardly from the inner surface of the body to abut against one of the siding members. An attachment portion has a first end attached to the body of the support portion and extends from the body to a second end. The second end has an engagement member being insertable between the siding members at a joint formed therebetween. The attachment portion has a curved segment along at least part of a length of the attachment portion defined between the first and second ends.

### CROSS-REFERENCE TO RELATED APPLICATIONS

This application claims priority to U.S. provisional patent application No. 62/653,717 filed Apr. 6, 2018, the entire contents of which are incorporated by reference herein.

### TECHNICAL FIELD

The application relates generally to hanging objects from structures and, more particularly, to a hanging device for supporting objects from overlapping siding members.

### BACKGROUND

It is often desired to support or hang objects on a vertical surface containing overlapping siding members. Some conventional brackets or hangers used for this purpose deform or break under the weight of the object being supported, or are not properly secured between the overlapping siding members when the object is being supported. Some conventional brackets or hangers require damaging the siding by using nails or screws to secure the brackets through the siding.

### SUMMARY

In one aspect, there is provided a hanging device attachable to overlapping siding members to support an object therefrom, the hanging device comprising: a support portion having a body defining an outer surface and an inner surface, a retaining structure on the outer surface of the body to support the object, and a support protrusion extending outwardly from the inner surface of the body to abut against one of the siding members; and an attachment portion having a first end attached to the body of the support portion and extending from the body to a second end, the second end having an engagement member being insertable between the siding members at a joint formed therebetween, the attachment portion having a curved segment along at least part of a length of the attachment portion defined between the first and second ends.

In another aspect, there is provided a method of supporting an object from overlapping siding members, the method comprising: positioning an upper portion of a hanging device in a joint formed between the siding members to suspend a lower portion of the hanging device from the siding members, the lower portion having a retaining structure extending outwardly from an outer surface thereof and a support protrusion extending outwardly from an inner surface thereof; and supporting the object from the retaining structure.

### DESCRIPTION OF THE DRAWINGS

Reference is now made to the accompanying figures in which:

FIG. 1A is a perspective view of an embodiment of a hanging device attached to overlapping siding members;

FIG. 1B is a front view of the hanging device and the overlapping siding members of FIG. 1A;

FIG. 2A is a perspective view of the hanging device of FIG. 1A;

FIG. 2B is another perspective view of the hanging device of FIG. 1A;

FIG. 2C is a side elevational view of the hanging device of FIG. 1A;

FIG. 3A is a side elevational view of the hanging device and the overlapping siding members of FIG. 1A;

FIG. 3B is an enlarged view of the highlighted portion IIIB-IIIB in FIG. 3A;

FIG. 3C is a side elevational view of the hanging device of FIG. 1A and overlapping siding members having a different configuration;

FIGS. 4A to 4F are perspective views of a hanging device similar to that shown in FIG. 1A, with different embodiments of a retaining structure of the hanging device;

FIG. 5A is a perspective view of another embodiment of a hanging device; and

FIG. 5B is a side elevational view of the hanging device of FIG. 5A.

### DETAILED DESCRIPTION

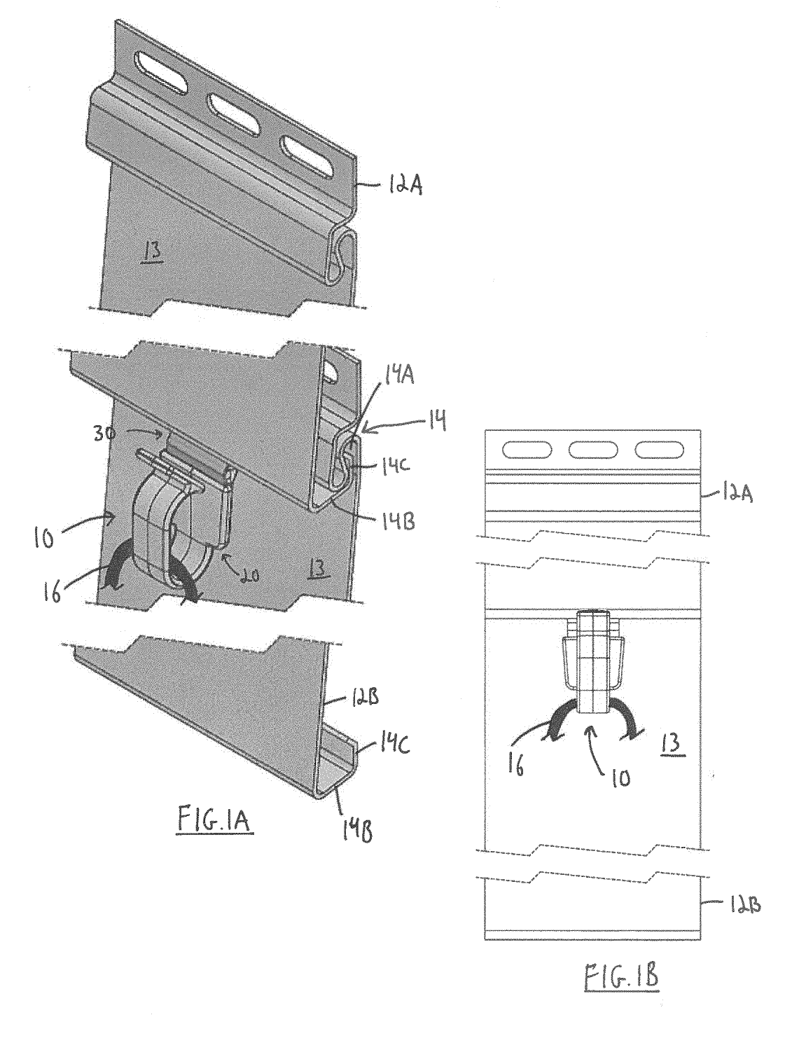

FIGS. 1A and 1B show a hanging device 10 inserted between, and supported from, overlapping upper and lower siding members 12A, 12B. The siding members 12A, 12B are panels in the depicted embodiment which extend horizontally. The siding members 12A, 12B are exterior siding members used on a vertical wall of a home or building. The siding members 12A, 12B are made from vinyl in the depicted embodiment, although other materials (e.g. aluminum, other metal, wood, etc.) are also possible. Each of the siding members 12A, 12B defines an outer surface 13 which faces away from the wall of the building, and which is exposed to view.

The upper and lower siding members 12A, 12B overlap and meet at a joint 14. The joint 14 is formed where the lower end of the upper siding member 12A meets the upper end of the lower siding member 12B. For the siding members 12A, 12B shown in FIGS. 1A and 1B, the joint 14 includes a groove 14A formed at the upper end of each siding member 12A, 12B, and a lip 14B with a transverse upright segment 14C at the lower end of each siding member 12A, 12B. The upper and lower siding members 12A, 12B are joined at the joint 14 by inserting the upright segment 14C of the lip 14B of the upper siding member 12A into the groove 14A of the lower siding member 12B. It will be appreciated that other configurations for the siding members 12A, 12B and their joint 14 are possible, and an example of an alternate configuration for the siding members 12A, 12B is described below.

Still referring to FIGS. 1A and 1B, the hanging device 10 includes receiving or support elements which are used to support an object 16 thereon. The hanging device 10 may therefore be used to support any suitable object 16, including but not limited to, lights, ornamental decorations, signs, and address or house numbers. Notably, the hanging device 10 is attached to and supported on the siding members 12A, 12B without requiring holes to be formed in, or adhesives to be applied to, the siding members 12A, 12B. As described in detail below, the hanging device 10 is configured to be inserted into the joint 14 between the upper and lower siding members 12A, 12B so that the object 16, supported by the hanging device 10, is also at least partially indirectly supported by the siding members 12A, 12B.

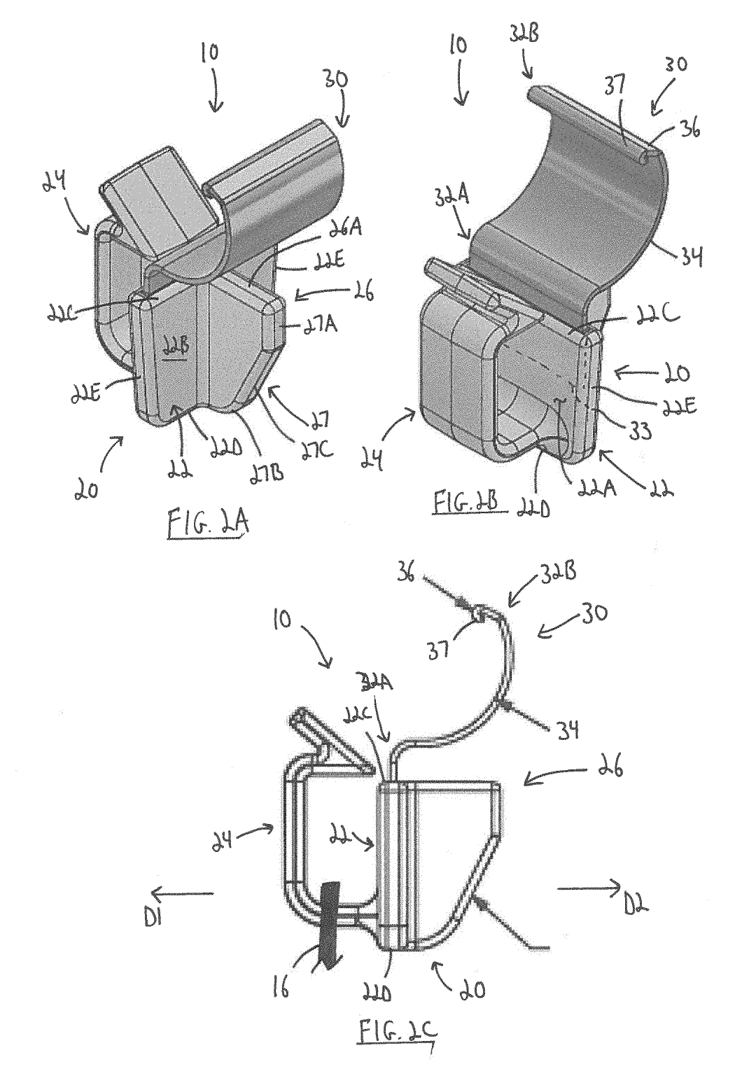

Referring to FIGS. 2A to 2C, the hanging device 10 has a support portion 20 and an attachment portion 30. The support portion 20 is the component of the hanging device 10 against which the object 16 is retained. The attachment portion 30 is the component of the hanging device 10 that is used to mount the hanging device 10 to the joint 14 between the siding members 12A, 12B. The support and attachment portions 20,30 are now described in greater detail.

The support portion 20 has a body 22 which forms the corpus of the support portion 20 and provides structure thereto. In the depicted embodiment, the body 22 is a three-dimensional object having a thickness, a width, and a height. As such, the body 22 defines an outer surface 22A that is exposed and faces outwardly away from the siding members 12A, 12B when the hanging device 10 is mounted thereto, and an inner surface 22B that is hidden and faces inwardly toward the siding members 12A, 12B. The body 22 also has an upper edge 22C, a lower edge 22D, and side edges 22E which each extend upright between the upper and lower edges 22C,22D. The upper, lower, and side edges 22C,22D,22E define a periphery of the body 22. In the depicted embodiment, the periphery of the body 22 has a rectangular shape. The body 22 is therefore a rectangular cuboid or rectangular parallelepiped, and it will be appreciated that other shapes for the body 22 are also possible.

The support portion 20 also has a retaining structure 24 to support the object 16. The nature of the support provided to the object 16 by the retaining structure 24 may vary depending on the configuration of the retaining structure 24. For example, the retaining structure 24 may support the object 16 by retaining it, suspending it, fastening to it, and receiving it, among other possibilities. In the embodiment shown in FIGS. 2A to 2C, the retaining structure 24 is a hook with a portion attached to the body 22, and which projects outwardly from the outer surface 22A of the body 22. The hook configuration of the retaining structure 24 allows the object 16 to be suspended therefrom. In an alternate embodiment, the retaining structure 24 is a recess or groove in the outer surface 22A of the body 22. The recessed configuration of the retaining structure 24 allows the object 16 to be inserted into the body 22 to be supported thereby. Many other configurations for the retaining structure 24 are possible and described in greater detail below.

The support portion 20 also has a support protrusion 26 extending outwardly away from the inner surface 22B of the body 22. The support protrusion 26 is a projection from the body 22 that abuts against the outer surface 13 of one of the siding members 12A, 12B to help distribute at least some of the weight of the object 16 to the siding members 12A, 12B, as described in greater detail below. In FIGS. 2A to 2C, the retaining structure 24 extends outwardly away from the outer surface 22A of the body 22 in a first direction D1 away from the siding members 12A, 12B, and the support protrusion 26 extends outwardly away from the inner surface 22B of the body 22 in a second direction D2 that is opposite to the first direction D1 and toward the siding members 12A, 12B. The body 22, retaining structure 24, and support protrusion 26 are all part of a monolithic structure. The body 22, retaining structure 24, and support protrusion 26 are all integral with one another, and thus form a single, unitary construction. The body 22, retaining structure 24, and support protrusion 26 are a single component. The one-piece body 22, retaining structure 24, and support protrusion 26 may be formed from an injectable material, such as a thermoplastic (e.g. polycarbonate), during a molding process.

In FIGS. 2A to 2C, the point on the inner surface 22B from which the support protrusion 26 extends outwardly away from the body 22 is within the periphery of the body 22. More particularly, the point on the inner surface 22B from which the support protrusion 26 extends outwardly from the body 22 is between the side edges 22E of the body 22. The support protrusion 26 is therefore a localised projection from the inner surface 22B of the body 22, and it may also extend outwardly from a point that is between the upper and lower edges 22C,22D. The support protrusion 26 is a three-dimensional object having a thickness, a width, and a height. As such, the support protrusion 26 has a top edge 26A and an abutting edge 27 that is transverse to the top edge 26A, and which extends in a generally downward direction from the top edge 26A. The top and abutting edges 26A,27 of the support protrusion 26 form a triangular-shaped wedge in the depicted embodiment. The abutting edge 27 includes an upper segment 27A, a lower segment 27B beneath the upper segment 27A, and a middle segment 27C extending between the upper and lower segments 27A,27B. The middle segment 27C is transverse to the upper segment 27A. The middle segment 27C extends from the upper segment 27A towards the inner surface 22B. One end of the middle segment 27C is closer to the inner surface 22B of the body 22 than the other end of the middle segment 27C. Other configurations for the support protrusion 26 are possible, and at least one other configuration is described in greater detail below.

Still referring to FIGS. 2A to 2C, the attachment portion 30 has a first end 32A and an opposite second end 32B. The first end 32A is attached to the upper edge 22C of the body 22 of the support portion 20, and the attachment portion 30 extends from the first end 32A to the second end 32B. In the depicted embodiment, an embedded section 33 of the attachment portion 30 is disposed within the body 22 of the support portion 20. The embedded section 33 extends into the body 22 past the first end 32A. The embedded section 33 may be overmolded with a thermoplastic to form the body 22 over the embedded section 33 and better secure the attachment portion 30 to the body 22. The second end 32B is an upper, distal end of the attachment portion 30 which is used to insert the attachment portion 30 into the joint 14 of the siding members 12A, 12B. The attachment portion 30 is curved along at least part of its length. More particularly, the attachment portion 30 has a curved segment 34 along at least part of its length between the first and second ends 32A,32B. As will be explained in greater detail below, the curved segment 34 serves as a pivot about which the attachment portion 30, and thus the hanging device 10, can rotate. The second end 32B has an engagement member 36 which is insertable between the siding members 12A, 12B at the joint 14. In the depicted embodiment, the engagement member 36 includes a curved portion 37 which forms a completely folded over hem. The curved portion 37 snaps or clips into place in the joint 14 of the siding members 12A, 12B. The attachment portion 30 is made of a resilient material, such as spring steel. Other materials are possible.

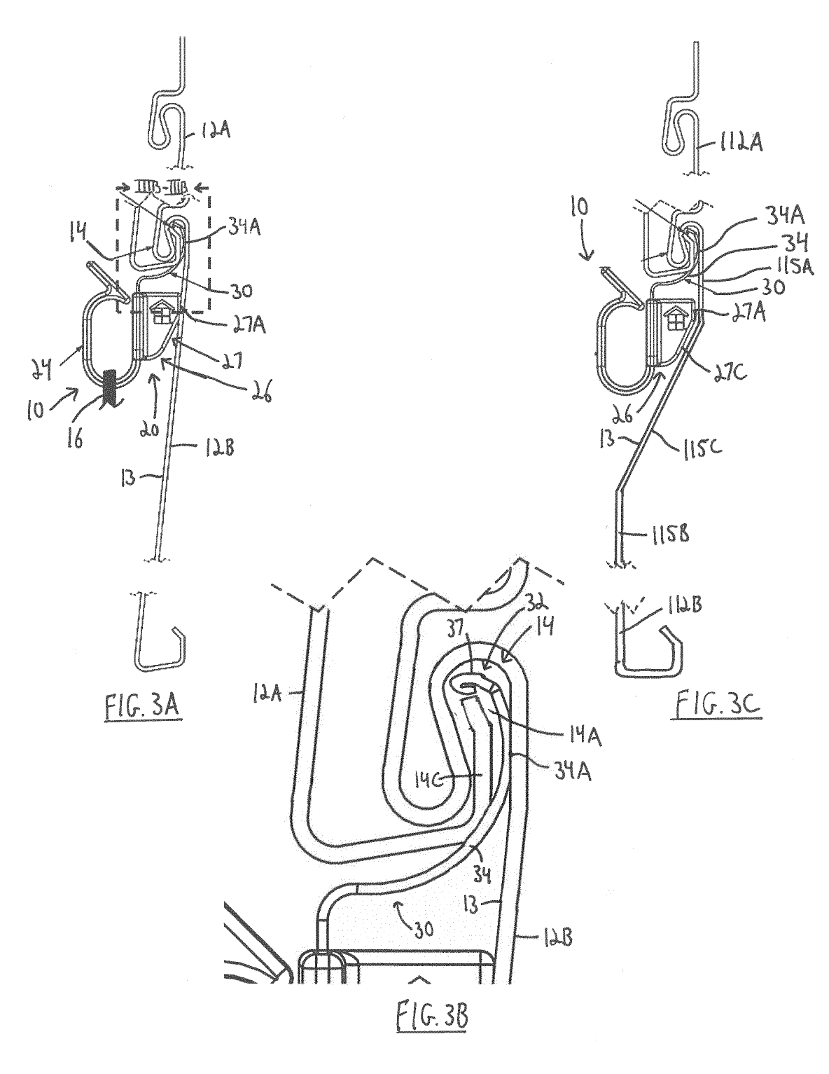

An example of an installation of the hanging device 10 on the siding members 12A, 12B will now be described with reference to FIGS. 3A and 3B. The attachment portion 30 is mounted to the joint 14 by sliding the second end 32B and its curved portion 37 along the outer surface 13 of the lower siding member 12B toward the joint 14. When the curved portion 37 abuts against the upright segment 14C of the upper siding member 12A, it pushes against the upright segment 14C and creates a passage for further upward insertion of the second end 32B. Once the curved portion 37 clears the upright segment 14C, the curved portion 37 snaps into the groove 14A such that the curved portion 37 sits on top of the distal end of the upright segment 14C. The curved portion 37 is thus hemmed in the groove 14A defined by the geometry of the joint 14, and is thus positioned to resist loads generated by the objet 16 which pull on the attachment portion 30.

The curved segment 34 of the attachment portion 30 also abuts against the outer surface 13 of the lower siding member 12B as the second end 32A is upwardly inserted. The abutment of the curved segment 34 with the outer surface 13 causes the attachment portion 30, and thus the hanging device 10, to pivot about the point of contact 34A of the curved segment 34 with the outer surface 13. The abutment of the curved segment 34 with the outer surface 13 causes the support portion 20 and the support protrusion 26 to pivot toward the outer surface 13 of the lower siding member 12B.

Still referring to FIGS. 3A and 3B, if the object 16 is heavy enough, it may cause the attachment portion 30 to pivot about the point of contact 34A of the curved segment 34 with the outer surface 13 so that the support protrusion 26 is caused to abut against the outer surface 13 of the lower siding member 12B. In FIG. 3A, the upper segment 27A of the abutting edge 27 is caused to abut against the outer surface 13. When the support protrusion 26 engages the outer surface 13, at least part of the weight of the object 16 is transferred from the hanging device 10 to the lower siding member 12B. The support protrusion 26 therefore helps to stabilize the hanging device 10, and also helps to distribute any vector of the weight of the object 16 which is on the retaining structure 24 to the siding members 12A, 12B, and thus, over a larger area. The support portion 26 therefore helps to provide additional hanging strength to the hanging device 10, and helps to prevent the retaining structure 24 from deforming downwards to the point where the object 16 may slip out.

FIG. 3C shows another common side profile of siding members 112A, 112B. Each of the siding members 112A, 112B have an upper segment 115A, a lower segment 115B, and a middle segment 115C extending between the upper and lower segments 115A, 115B. The upper and lower segments 115A, 115B are oriented substantially parallel to one another, and the middle segment 115C is transverse to both the upper and lower segments 115A, 115B. In the depicted embodiment, the middle segment 115C extends outwardly from a bottom of the upper segment 115A such that the lower segment 115B is more offset from the wall of the building than the upper segment 115A. Even for this configuration of the siding members 112A, 112B, the support protrusion 26 of the hanging device 10 is able to abut against the outer surface 13 of the lower siding member 112B to distribute at least part of the weight of the object to the lower siding member 112B. More particularly, if the object 16 is heavy enough, it may cause the attachment portion 30 to pivot about the point of contact of the curved segment 34 with the outer surface 13 so that the upper or middle segment 27A,270 of the abutting edge 27 of the support protrusion 26 is caused to abut against the outer surface 13 of the lower siding member 112B. In the depicted embodiment, the upper segment 27A of the abutting edge 27 is parallel to the upper segment 115A of the lower siding member 112B, and the middle segment 27C of the abutting edge 27 is parallel to the middle segment 115C of the lower siding member 112B. This configuration may help to better distribute the weight of the object 16 to the lower siding member 112B. The hanging device 10 disclosed herein is therefore capable of being used with siding members 12A, 12B, 112A, 112B which have varying side profiles.

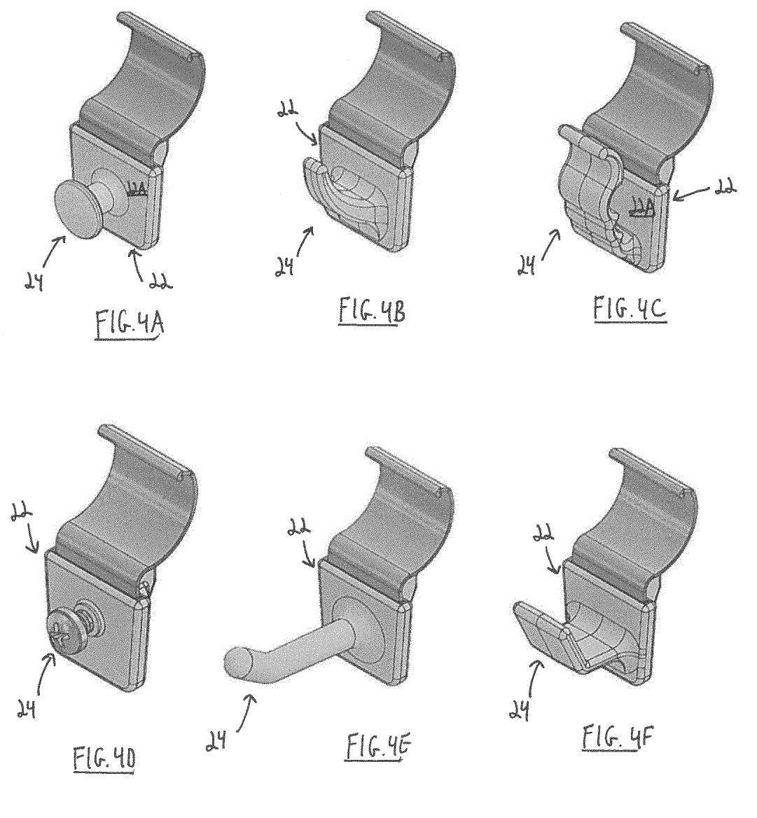

FIGS. 4A to 4F show different configurations for the retaining structure 24 described above, it being appreciated that retaining structure 24 may have even more configurations, and is not limited to the configurations disclosed herein. In FIG. 4A, the retaining structure 24 is a button which projects outwardly from the outer surface 22A of the body 22. The button configuration of the retaining structure 24 allows the object 16 to be mounted to the button retaining structure 24 via a recess in the object 16 to be mated to the retaining structure 24. In FIG. 4B, the retaining structure 24 is a tapered hook which projects outwardly from the body 22. The tapered hook configuration of the retaining structure 24 allows the object 16 to be suspended therefrom. In FIG. 4C, the retaining structure 24 is a snapping wire clip for various diameter cables, which projects outwardly from the body 22. The wire clip configuration of the retaining structure 24 allows the object 16 to be secured within a cavity defined by the wire clip between the retaining structure 24 and the outer surface 22A of the body 22. In FIG. 4D, the retaining structure 24 is a screw mount, which has a recessed portion in the body 20 into which a screw portion is inserted. The screw mount configuration of the retaining structure 24 allows the object 16 to be secured to the body 22 by inserting the screw portion through an opening in the object 16 and into the recessed portion. In FIG. 4E, the retaining structure 24 is a tool peg, which protrudes outwardly from the body 22. The tool peg configuration of the retaining structure 24 supports the object 16 by suspending it, or by inserting the tool peg into the object 16. In FIG. 4F, the retaining structure 24 is a rectangular hook which projects outwardly from the body 22. The rectangular hook configuration of the retaining structure 24 allows the object 16 to be suspended therefrom. It will therefore be appreciated that the retaining structure 24 of the hanging device 10 may be shaped in a number of different ways for different purposes.

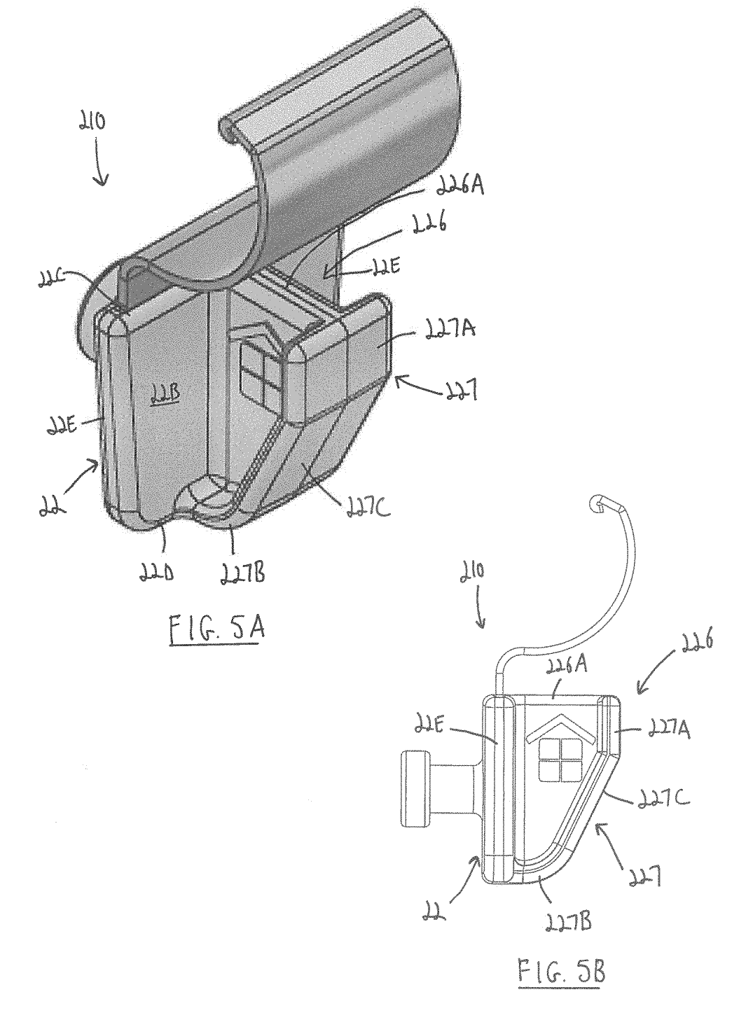

FIGS. 5A and 5B show another embodiment of the hanging device 210. The principal distinction between the hanging device 210 and the hanging device 10 described above is the support protrusion 226, and therefore some of the reference numbers for features of the hanging device 10 described above are used for features of the hanging device 210. In FIGS. 5A and 5B, the point on the inner surface 22B from which the support protrusion 226 extends outwardly away from the body 22 is within the periphery of the body 22. More particularly, the point on the inner surface 22B from which the support protrusion 226 extends outwardly from the body 22 is between the side edges 22E of the body 22. The support protrusion 226 is therefore a localised projection from the inner surface 22B of the body 22, and it may also extend outwardly from a point that is between the upper and lower edges 22C,22D. The support protrusion 226 is a three-dimensional object having a thickness, a width, and a height. In FIGS. 5A and 5B, the support protrusion 226 has a top edge 226A which extends towards and meets an abutting flange 227 that is transverse to the top edge 226A, and which extends in a generally downward direction from the top edge 226A. The abutting flange 227 includes an upper segment 227A, a lower segment 227B beneath the upper segment 227A, and a middle segment 227C extending between the upper and lower segments 227A,227B. The middle segment 227C is transverse to the upper segment 227A. Each of the upper, lower, and middle segments 227A,227B,227C of the abutting flange 227 flare outwardly in a direction parallel to the inner surface 22B of the body 22. The abutting edge 227 therefore has a greater surface area for engagement with the outer surface 13 of the lower siding panel 12B, 112B to help improve the stability of the hanging device 10,210, and to better distribute the loads generated by supporting the object 16.

Referring to FIGS. 3A and 3B, there is also disclosed a method of supporting the object 16 from overlapping siding members 12A, 12B. The method includes positioning an upper portion of the hanging device 10 in the joint 14 to suspend a lower portion of the hanging device 10 from the siding members 12A, 12B. The lower portion of the hanging device 10 has the retaining structure 24 extending outwardly from the outer surface 22A, and the support protrusion 26 extending outwardly from the inner surface 22B. The method includes supporting the object 16 from the retaining structure 24. The method and the installation of the hanging device 10,210 is practiced without the user having to use any tools. The user can mount the hanging device 10,210 using only their hands.

It is therefore appreciated that the hanging device 10,210 disclosed herein is usable on siding members 12A, 12B, 112A, 112B having different profiles, and thus adapts to the inherent variability of siding interfaces due to their material composition and how they are made. Furthermore, when the object 16 is supported on the hanging device 10,210, at least some of its weight can be distributed to the siding members 12A, 12B, 112A, 112B.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A hanging device attachable to overlapping siding members to support an object therefrom, the hanging device comprising:
a support portion having a body defining an outer surface and an inner surface, a retaining structure on the outer surface of the body to support the object, and a support protrusion extending outwardly from the inner surface of the body to abut against one of the siding members; and
an attachment portion having a first end attached to the body of the support portion and extending from the body to a second end, the second end having an engagement member being insertable between the siding members at a joint formed therebetween, the attachment portion having a curved segment along at least part of a length of the attachment portion defined between the first and second ends.

2. The hanging device of claim 1, wherein the attachment portion includes an embedded segment extending past the first end and disposed within the body of the support portion.

3. The hanging device of claim 1, wherein the retaining structure and the support protrusion are integral with the body.

4. The hanging device of claim 1, wherein the retaining structure, the support protrusion and the body are a single component.

5. The hanging device of claim 1, wherein the body of the support portion includes an upper edge, a lower edge, and side edges each extending between the upper and lower edges, the upper, lower, and side edges defining a periphery of the body, the support protrusion extending outwardly from the inner surface of the body at a location on the body between the side edges.

6. The hanging device of claim 5, wherein the periphery of the body has a rectangular shape.

7. The hanging device of claim 1, wherein the support protrusion has a top edge and an abutting edge being transverse to the top edge.

8. The hanging device of claim 7, wherein the abutting edge includes an upper segment, a lower segment beneath the upper segment, and a middle segment extending between the upper and lower segments, the middle segment being transverse to the upper segment.

9. The hanging device of claim 1, wherein the retaining structure extends outwardly from the outer surface of the body in a first direction, and the support protrusion extends outwardly from the inner surface in a second direction opposite to the first direction.

10. The hanging device of claim 1, wherein the engagement member includes a curved portion.

11. The hanging device of claim 10, wherein the curved portion is folded over.

12. The hanging device of claim 1, wherein the retaining structure is a hook.

13. The hanging device of claim 1, wherein the attachment portion is composed of spring steel.

14. A method of supporting an object from overlapping siding members, the method comprising:
positioning an upper portion of a hanging device in a joint formed between the siding members to suspend a lower portion of the hanging device from the siding members, the lower portion having a retaining structure extending outwardly from an outer surface thereof and a support protrusion extending outwardly from an inner surface thereof; and
supporting the object from the retaining structure.

15. The method of claim 14, wherein supporting the object includes pivoting the hanging device about a pivot formed at a point of contact between one of the siding members and the upper portion of the hanging device when the object is supported by the retaining structure.

16. The method of claim 14, wherein supporting the object includes abutting the support protrusion against one of the siding members when the object is supported by the retaining structure.

17. The method of claim 14, wherein positioning the upper portion of the hanging device includes positioning the upper portion of the hanging device without using a tool.
